(19) United States
(12) Patent Application Publication
(10) Pub. No.: US 2021/0302191 A1
(43) Pub. Date: Sep. 30, 2021

(54) ROUTE GUIDING APPARATUS

(71) Applicant: HONDA MOTOR CO., LTD., Tokyo (JP)

(72) Inventor: Kohei Noguchi, Tokyo (JP)

(21) Appl. No.: 17/192,140

(22) Filed: Mar. 4, 2021

(30) Foreign Application Priority Data
Mar. 31, 2020 (JP) 2020-061881

(51) Int. Cl. G01C 21/36; H04S 3/00; H04S 7/00

(52) U.S. Cl. CPC G01C 21/3629; H04S 7/303; H04S 3/002

(57) ABSTRACT

A control device has a plurality of speakers and includes an audio output portion mounted on a vehicle, a route searching portion that searches for a guidance route to a destination, and a sound image localization processing portion that controls the audio output portion based on the guidance route searched by the route searching portion and that displaces a position to localize a sound image of predetermined notification sound output from each of the speakers discretely corresponding to the guidance route.

### INCORPORATION BY REFERENCE

The present application claims priority under 35 U.S.C. § 119 to Japanese Patent Application No. 2020-061881 filed on Mar. 31, 2020. The content of the application is incorporated herein by reference in its entirety.

### TECHNICAL FIELD

The present invention relates to a route guiding apparatus.

### BACKGROUND ART

There has heretofore been known an apparatus that causes a guidance route to a destination to be notified of by audio.

For example, Patent Literature 1 discloses a route guiding system that sets a guidance output spot and performs audio output by sound image localization when an own vehicle arrives at the guidance output spot. The route guiding system divides the phrase that guides an exit road on a search route into a predetermined number and outputs each divided phrase by audio at the position of a virtual sound source.

### CITATION LIST

### Patent Literature

[Patent Literature 1] JP-A No. 2009-128316

### SUMMARY OF THE INVENTION

### Technical Problem

There has however been a demand to simply provide more information in order to make route guidance to a destination more reliable where a route is guided by predetermined notification sound.

The present invention has been achieved in view of the above-mentioned circumstances, and it is an object thereof to make it easier for a rider to understand route information in route guidance by predetermined notification sound.

### Solution to Problem

In order to achieve the object, according to a first feature of the present invention, there is provided a route guiding apparatus that includes: an audio output portion (151, 153, 155) including a plurality of speakers (171 to 178) and mounted on a vehicle (1); a route searching portion (131) searching for a guidance route to a destination; and a sound image localization processing portion (133) controlling the audio output portion (151, 153, 155) based on the guidance route searched by the route searching portion (131), the sound image localization processing portion (133) discretely displacing a position in association with the guidance route, the position being for localizing a sound image of predetermined notification sound output from each of the speakers (171 to 178).

Also, in the above-described configuration, there is provided a position detection portion (103) that detects a position of the vehicle (1). The sound image localization processing portion (133) may be configured to cause a distance to be notified of by changing an interval between positions to localize the sound image, the distance being a distance to a guide object where guidance in a traveling direction is planned.

Further, in the above-described configuration, when the distance to the guide object is less than or equal to a first set distance, the sound image localization processing portion (133) may be configured to displace the position to localize the sound image for each first interval, and when the distance to the guide object is less than or equal to a second set distance, the sound image localization processing portion (133) may be configured to displace the position to localize the sound image for each second interval, the second set distance being smaller in value than the first set distance, and the second interval being shorter than the first interval.

Moreover, in the above-described configuration, the route searching portion (131) detects a guide crossing (200) as the guide object. The sound image localization processing portion (133) may be configured to, when the vehicle (1) is traveling on an approach road where the vehicle (1) enters the detected guide crossing (200), and a distance to the guide crossing (200) becomes less than or equal to a third set distance, displace the position to localize the sound image of the notification sound from within the guide crossing (200) in the direction of an exit road where the vehicle exits the guide crossing (200), the third set distance being smaller in value than the second set distance.

Additionally, in the above-described configuration, the sound image localization processing portion (133) may be configured to, when the guide object is the guide crossing (200), set a reference position to a position of a distance set in advance from a side end of the guide crossing (200), and change the position to localize the sound image by the first interval or the second interval on the basis of a distance from the present position of the vehicle (1) to the reference position.

Additionally, in the above-described configuration, the sound image localization processing portion (133) may be configured to continuously displace the position to localize the sound image within the guide crossing (200).

Additionally, in the above-described configuration, the sound image localization processing portion (133) may be configured to prevent the speakers (171 to 178) from outputting the notification sound when the distance to the guide object is away from the first set distance.

### Advantageous Effects of Invention

According to the first feature of the present invention, there is provided a route guiding apparatus that includes an audio output portion having a plurality of speakers and mounted on a vehicle, a route searching portion that searches for a guidance route to a destination, and a sound image localization processing portion that controls the audio output portion based on the guidance route searched by the route searching portion and discretely displaces a position to localize a sound image of predetermined notification sound output from each of the speakers in association with the guidance route.

Thus, since the position to localize the sound image of the predetermined notification sound output from the speaker is displaced discretely corresponding to the guidance route, route information can be notified to a rider in an easy-to-understand manner.

Also, in the above-described configuration, there is provided a position detection portion that detects a position of the vehicle. The sound image localization processing portion may be configured to cause a distance to a guide object where guidance in a traveling direction is planned in the guidance route to be notified of by changing an interval between positions to localize the sound image.

Thus, since the distance to the guide object can be notified to the rider by changing the interval of the notification sound, route information can be notified to the rider in an easy-to-understand manner.

Further, in the above-described configuration, the sound image localization processing portion may be configured to displace the position to localize the sound image for each first interval when the distance to the guide object is less than or equal to a first set distance, and to displace the position to localize the sound image for each second interval shorter than the first interval when the distance to the guide object is less than or equal to a second set distance smaller in value than the first set distance.

Thus, since the distance to the guide object can be notified to the rider by changing the interval of the notification sound, route information can be notified to the rider in an easy-to-understand manner.

Moreover, in the above-described configuration, the route searching portion detects a guide crossing as the guide object. The sound image localization processing portion may be configured to, when the vehicle is traveling on an approach road where the vehicle enters the detected guide crossing, and a distance to the guide crossing becomes less than or equal to a third set distance smaller in value than the second set distance, displace the position to localize the sound image of the notification sound from within the guide crossing in the direction of an exit road where the vehicle exits the guide crossing.

Thus, it is possible to cause the direction of the exit road in the guide crossing to be notified to the rider in an easy-to-understand manner.

Additionally, in the above-described configuration, the sound image localization processing portion may be configured to, when the guide object is the guide crossing, set a reference position to a position of a distance set in advance from a side end of the guide crossing and change the position to localize the sound image by the first interval or the second interval on the basis of a distance from the present position of the vehicle to the reference position.

Thus, it is possible to set the reference position to the determined position of the guide crossing and change the interval to localize the sound image, based on the distance to the set reference position. Therefore, it makes it easier for the rider to recognize the distance to the guide crossing.

Moreover, in the above-described configuration, the sound image localization processing portion may be configured to continuously displace the position to localize the sound image within the guide crossing.

Thus, the guidance on the traveling direction in the guide crossing can be notified to the rider in an easy-to-understand manner.

Furthermore, in the above-describe configuration, the sound image localization processing portion may be configured to prevent the speakers from outputting the notification sound when the distance to the guide object is away from the first set distance.

Thus, it is possible to reduce power consumption of the vehicle.

### BRIEF DESCRIPTION OF DRAWINGS

FIG. 1 is a side view of a motorcycle.

FIG. 2 is a top view of the motorcycle.

FIG. 3 is a view when the front of the motorcycle is viewed from behind.

FIG. 4 is a block configuration view showing a configuration of a control device.

FIG. 5 is a view showing a configuration of an audio output system mounted in a vehicle.

FIG. 6A and FIG. 6B are respectively a view showing directivity of a general speaker, and a view showing directivity of a speaker included in a speaker array.

FIG. 7 is a view showing a setting method of a reference position.

FIG. 8 is a view showing localization positions set within a guide crossing.

FIG. 9 is a view showing an interval between localization positions.

FIG. 10 is a view showing an interval between localization positions.

FIG. 11 is a view showing an interval between localization positions.

FIG. 12 is a view showing a multi-forked road.

FIG. 13 is a view showing an annular intersection.

FIG. 14 is a view showing where guide objects are continuous.

FIG. 15 is a flowchart showing the operation of a control portion.

### DESCRIPTION OF EMBODIMENTS

An embodiment of the present invention will hereinafter be described with reference to the drawings. In the following explanations, the description of directions such as the front/rear, left/right, and up/down directions is the same as the directions with respect to a vehicle body unless otherwise specified. Further, a reference sign FR in each figure indicates the front of the vehicle body, a reference sign UP indicates the upper side of the vehicle body, a reference sign LH indicates the left side of the vehicle body, and a reference sign RH indicates the right side of the vehicle body.

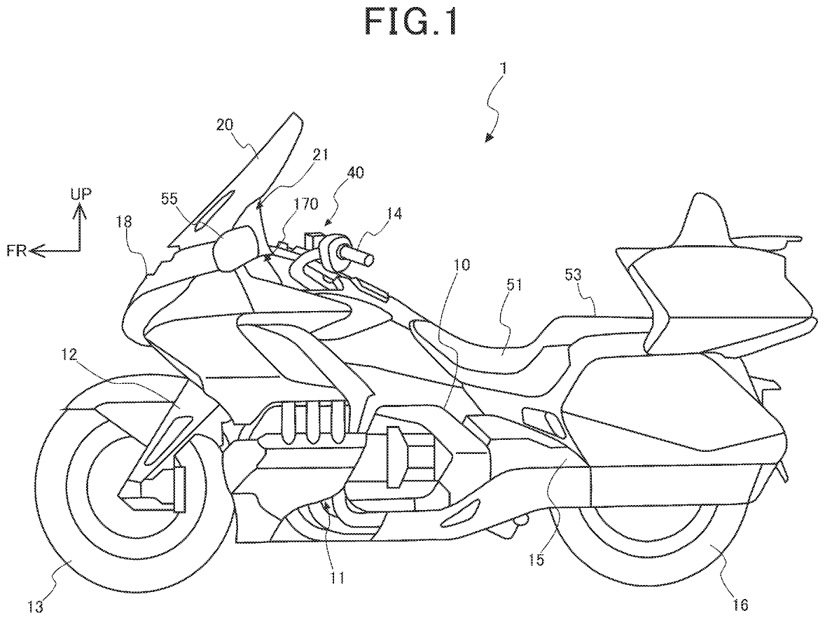

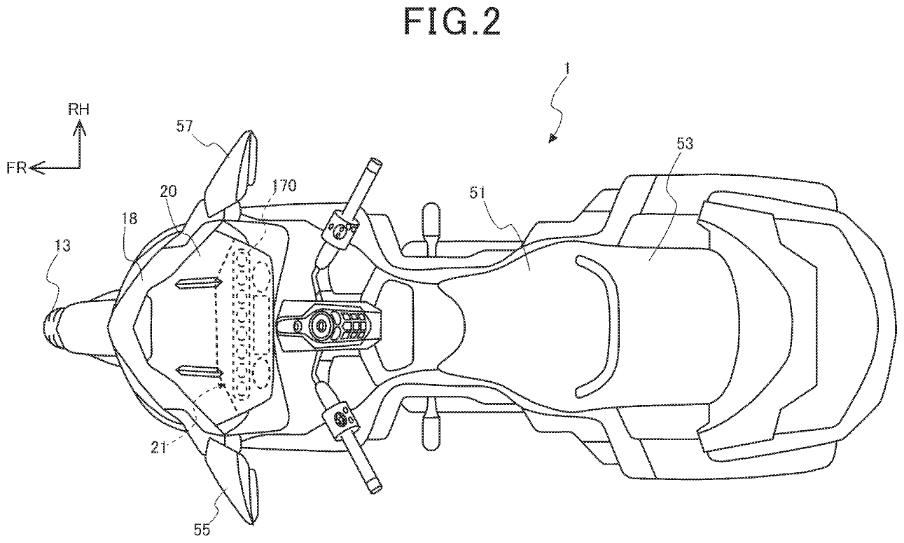

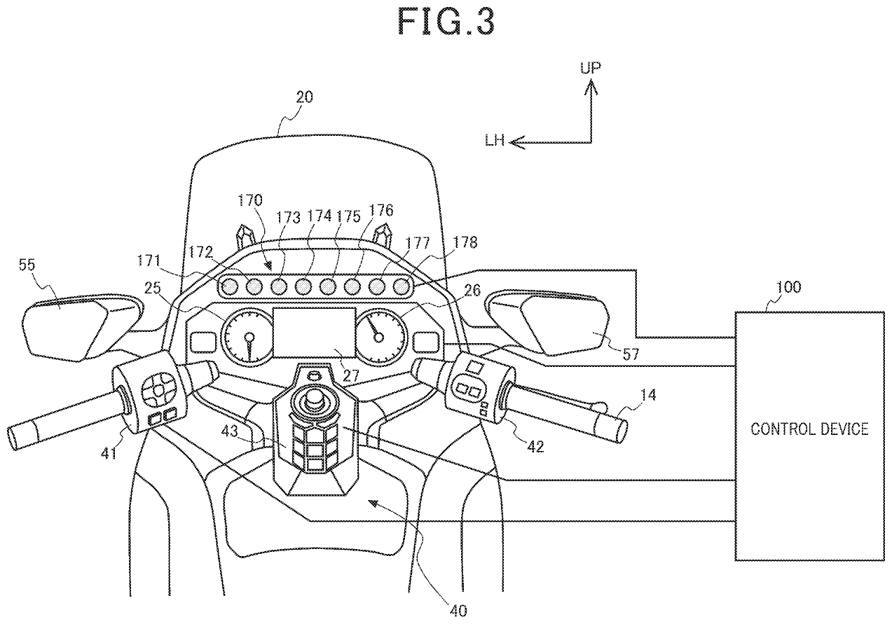

FIG. 1 is a side view of a motorcycle that is an embodiment of a vehicle of the present invention. FIG. 2 is a top view of the motorcycle. FIG. 3 is a view when the front of the motorcycle is viewed from behind. In the following, a vehicle equipped with a control device 100 to be described later is referred to as a vehicle 1. FIGS. 1 through 3 show a case where the vehicle 1 is a motorcycle, but the vehicle 1 is not limited to the motorcycle.

The vehicle 1 includes, as shown in FIG. 1, a body frame 10 and a power unit 11 supported by the body frame 10. A front wheel 13 is supported steeringly from side to side at the front portion of the body frame 10 through front forks 12 that double as a front cushion. A steering handlebar 14 is provided above the front forks 12. A rear wheel 16 is supported swingably up and down at the lower rear portion of the body frame 10 through a swing arm 15. A pillion passenger seat 53 is inserted between the body frame 10 and the swing arm 15. The power unit 11 includes an engine and a transmission mechanism and rotatably drives the rear wheel 16 through a shaft drive mechanism.

As shown in FIG. 2, the body frame 10 supports a rider seat 51 on which a rider sits behind the steering handlebar 14, and the pillion passenger seat 53 on which a pillion passenger sits. Further, the body frame 10 supports a body cover 18 that covers almost the entire body frame 10. A front screen 20 or the like that covers the front of the occupant is attached to the body cover 18. A meter panel 21 displaying various information thereon and a speaker array 170 functioning as a speaker unit are arranged between the front screen 20 and the steering handlebar 14. A manipulation portion 40 for performing a menu selection or the like in the meter panel 21 is arranged around the steering handlebar 14. Further, a left mirror 55 and a right mirror 57 are placed on the body cover 18. The left mirror 55 and the right mirror 57 are placed outside of the front screen 20 in the vehicle width direction of the vehicle 1.

The control device 100 electrically connected to the meter panel 21, the speaker array 170 and the manipulation portion 40 is installed in the vehicle 1. The control device 100 is inputted with various instructions from the rider through the manipulation portion 40 to control the display contents of the meter panel 21 and the output audio of the speaker array 170.

FIG. 3 is a view showing the circumference of the meter panel 21 as viewed from the rider together with the control device 100. The meter panel 21 includes instruments 25 and 26 that display information (speed, engine rotational speed, etc.) about the motorcycle and a display portion 27 that displays various information. The display portion 27 has a known display panel such as a liquid crystal panel and displays various information to the rider or the like under the control of the control device 100.

The speaker array 170 is arranged above the instruments 25 and 26 of the meter panel 21 and the display portion 27. Since the speaker array 170 is arranged above the instruments 25 and 26 of the meter panel 21 and the display portion 27, it is possible to place the speaker array at a nearer position to the rider's ear and reduce sound attenuation by a handle or the like.

The speaker array 170 is a speaker unit that has a plurality of speakers arranged in the width direction of the vehicle 1 and that expands in the width direction, an area where the rider or the like can hear. The present configuration is a configuration in which a first speaker 171, a second speaker 172, a third speaker 173, a fourth speaker 174, a fifth speaker 175, a sixth speaker 176, a seventh speaker 177, and an eighth speaker 178 are arranged in a row from the left as seen from the rider. With this configuration, even if the heads of the rider and the pillion passenger are moved to the left and right sides, etc., it is possible to deliver sound output from any of the first to eighth speakers 171 to 178 to the ears of the rider and the pillion passenger. Further, although the present embodiment will describe the case where the number of the speakers included in the speaker array 170 is eight, the number of speakers is arbitrary and can be changed as appropriate. Increasing the number of the speakers that configure the speaker array 170 enables the accuracy of a localization position of a sound image output from the speaker array 170 to be improved.

Also, the vehicle 1 has as the manipulation portion 40, left and right handlebar manipulation portions 41 and 42 respectively provided on the left and right sides of the manipulation handlebar 14, and a central manipulation portion 43 provided between the speaker array 170 and a seat 17 and provided at the center position in the vehicle width direction. The manipulation portion 40 having these includes a switch group that constitutes a manipulation system related to the display portion 27 of the meter panel 21 and the speaker array 170 in addition to a switch group that constitutes a general manipulation system such as the manipulation of a light device such as a blinker of the vehicle 1, and ON/OFF of the power unit 11.

Further, of the speaker array 170 with the speakers arranged in one row, the first speaker 171 installed at the left end is arranged outside of the width of the vehicle 1 in the vehicle width direction, and the eighth speaker 178 installed at the right end is arranged outside of the width of the vehicle 1 in the vehicle width direction. Specifically, the width of the vehicle 1 is the width of the rider seat 51, and the first speaker 171 and the eighth speaker 178 are arranged outside of the end in the vehicle width direction of the rider seat 51 as viewed in the vehicle width direction. Further, the first speaker 171 installed at the left end is arranged inside of the left mirror 55 in the vehicle width direction, and the eighth speaker 178 installed at the right end is arranged inside of the right mirror 57 in the vehicle width direction.

Furthermore, the vehicle 1 has as the manipulation portion 40, left and right handlebar manipulation portion 41 and 42 respectively provided on the left and right sides of the manipulation handlebar 14, and a central manipulation portion 43 provided between the speaker array 170 and a seat 17 and provided at the center position in the vehicle width direction. The manipulation portion 40 includes a switch group that constitutes the manipulation system related to the display portion 27 of the meter panel 21 and the speaker array 170 in addition to a switch group that constitutes a general manipulation system such as the manipulation of a light device such as a blinker of the vehicle 1, and ON/OFF of the power unit 11.

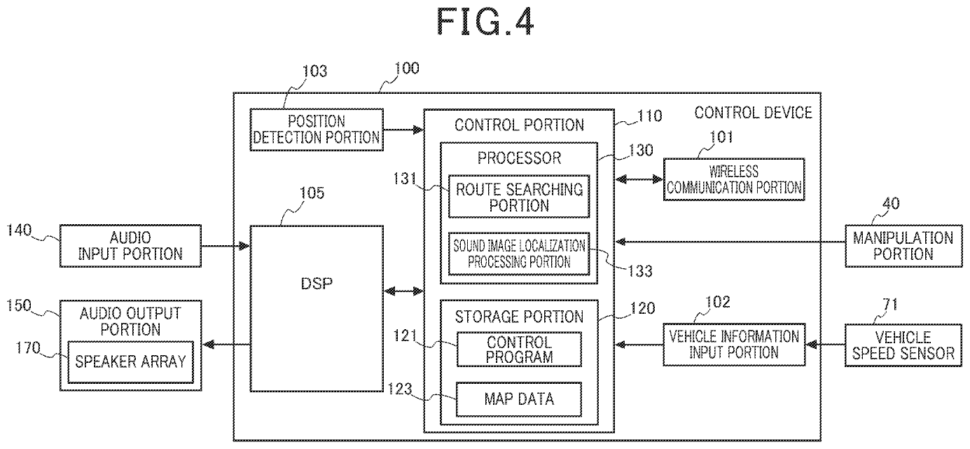

FIG. 4 is a block configuration view showing a configuration of the control device 100.

The control device 100 is operated as a route guiding apparatus of the present invention. The configuration of the control device 100 will be described with reference to FIG. 4.

The control device 100 includes a wireless communication portion 101 (transmitter/receiver), a vehicle information input portion 102 (circuit), a position detection portion 103, a DSP 105, and a control portion 110. The DSP is an abbreviated notation of a Digital Signal Processor.

The wireless communication portion 101 performs wireless communication according to a prescribed communication protocol and is connected to a mobile communication network. The wireless communication portion 101 transmits and receives communication data through the connected mobile communication network. For example, the wireless communication portion 101 performs data communication with an unillustrated server device to download road traffic information from the server device.

The vehicle information input portion 102 functions as a connection interface with the vehicle 1 and inputs vehicle information from the vehicle 1. The vehicle information includes sensor data of a vehicle speed sensor 71. The vehicle speed sensor 71 is a sensor that detects the vehicle speed of the vehicle 1. The vehicle speed sensor 71 detects the vehicle speed of the vehicle 1 and outputs sensor data indicative of the detected vehicle speed to the control device 100.

The position detection portion 103 detects the present position of the vehicle 1. The position detection portion 103 includes a GNSS receiver that receives a GNSS signal and a processor that calculates the present position of the vehicle 1, based on the GNSS signal received by the GNSS receiver. The illustration of the GNSS receiver and the processor is omitted. The position detection portion 103 outputs position information indicative of the present position of the vehicle 1 determined by calculation to the control portion 110. GNSS is an abbreviated notation of a Global Navigation Satellite System.

The DSP 105 inputs audio data included in the communication data received by the wireless communication portion 101. The DSP 105 generates an audio signal on the basis of the input audio data. The generated audio signal is an analog signal and is generated on a plurality of channels. The DSP 105 outputs the generated analog audio signal to the audio output portion 150.

Further, an audio input portion 140 is connected to the DSP 105.

The audio input portion 140 has a microphone. The audio input portion 140 converts user's voice into an analog audio signal and outputs the same to the DSP 105. The DSP 105 converts the audio signal input from the audio input portion 140 into a digital signal and outputs the same to the control portion 110. The audio input portion 140 collects the rider's voice by using a headset worn by the rider or a microphone pre-installed in the vehicle 1. For example, short range wireless communication such as Bluetooth or the like is used for communication between the audio input portion 140 and the control device 100. Bluetooth is a registered trademark.

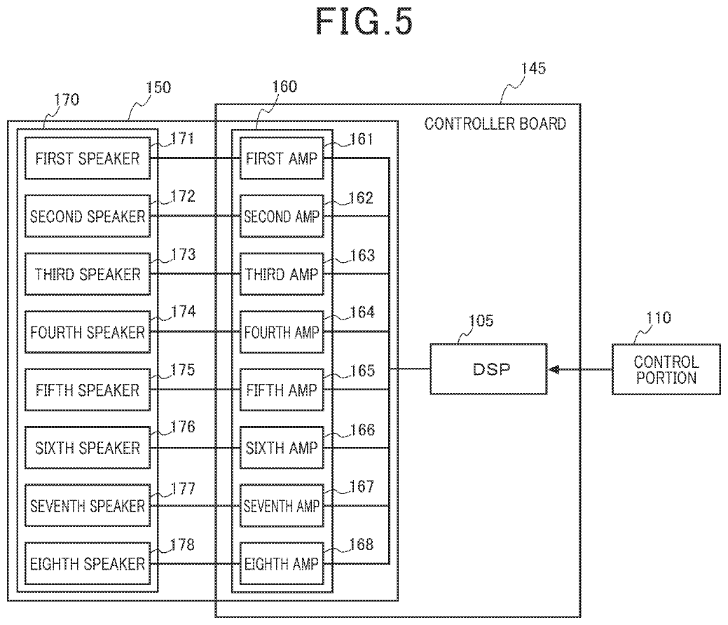

A description will now be made about a configuration of an audio output system installed in the vehicle 1 with reference to FIG. 5. FIG. 5 is a view showing the configuration of the audio output system of the vehicle 1. The audio output system is mounted on a controller board 145. The controller board 145 is equipped with the DSP 105 and a signal amplifying portion 160. In addition, the controller board 145 includes a power supply portion installed in the DSP 105, which supplies power from a battery. The illustration of the power supply portion is omitted.

The signal amplifying portion 160 includes a first AMP 161, a second AMP 162, a third AMP 163, a fourth AMP 164, a fifth AMP 165, a sixth AMP 166, a seventh AMP 167, and an eighth AMP 168. AMP is an abbreviated notation of Amplifier.

The first AMP 161 is connected to the first speaker 171. The second AMP 162 is connected to the second speaker 172. The first AMP 161 amplifies an input audio signal and outputs the same to the first speaker 171. The second AMP 162 amplifies an input audio signal and outputs the same to the second speaker 172.

The third AMP 163 is connected to the third speaker 173. The fourth AMP 164 is connected to the fourth speaker 174. The fifth AMP 165 is connected to the fifth speaker 175. The sixth AMP 166 is connected to the sixth speaker 176.

The third AMP 163 amplifies an input audio signal and outputs the same to the third speaker 173. The fourth AMP 164 amplifies an input audio signal and outputs the same to the fourth speaker 174. The fifth AMP 165 amplifies an input audio signal and outputs the same to the fifth speaker 175. The sixth AMP 166 amplifies an input audio signal and outputs the same to the sixth speaker 176.

The seventh AMP 167 is connected to the seventh speaker 177. The eighth AMP 168 is connected to the eighth speaker 178. The seventh AMP 167 amplifies an input audio signal and outputs the same to the seventh speaker 177. The eighth AMP 168 amplifies an input audio signal and outputs the same to the eighth speaker 178.

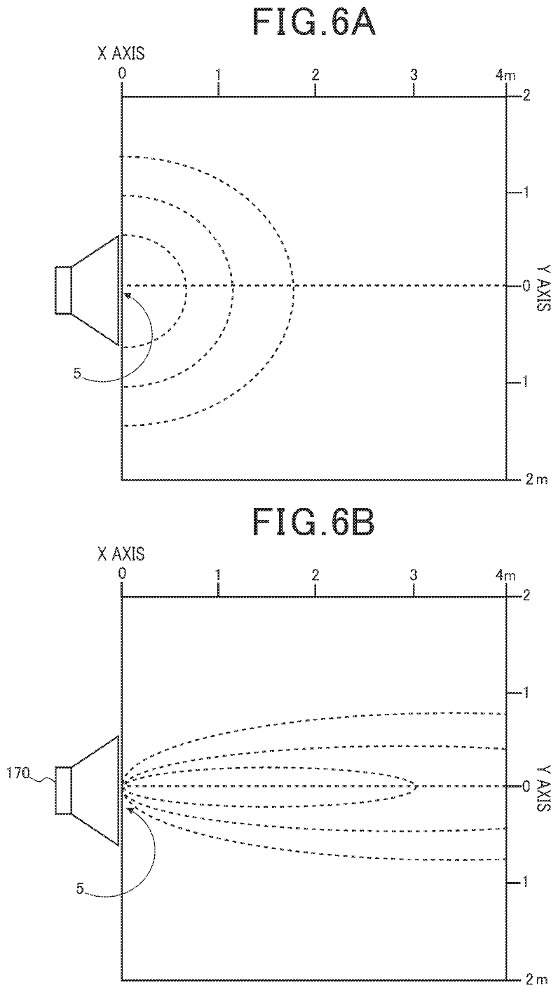

Next, the directivity of each speaker included in the speaker array 170 will be described with reference to FIGS. 6A and 6B. FIGS. 6A and 6B shows the directivities of a general speaker and each speaker included in the speaker array 170. The speaker mounted on the vehicle 1 has super-directivity, and the sound output from the speaker is high in linearity and sharp in directivity.

Each of the speakers 171 to 178 that constitute the speaker array 170 has super-directivity, and the sound output from each speaker is high in linearity and sharp in directivity.

FIG. 6A shows a transmission range of sound output from a speaker used usually in a general way, and FIG. 6B shows a transmission range of sound output from each speaker that constitutes the speaker array 170 having the super-directivity. The horizontal axes of FIGS. 6A and 6B respectively indicate distances in an X-axis direction, and the vertical axes thereof respectively indicate distances in a Y-axis direction. The X-axis direction is the direction perpendicular to a sound output surface 5 of the speaker, and the Y-axis direction is the direction parallel to the sound output surface 5. Further, the origin in the Y-axis direction is set to the central position in the Y-axis direction of the sound output surface 5 of the speaker. As is obvious when comparing FIG. 6A and FIG. 6B, it is understood that the speaker mounted on the vehicle 1 is narrow in horizontal (lateral) spread, but the sound is transmitted far.

Referring back to FIG. 4, the configuration of the control device 100 will be described continuously.

The control portion 110 is a computer device that includes a storage portion 120 and a processor 130. The storage portion 120 includes a memory such as a ROM, a RAM or the like. The ROM is an abbreviated notation of a Read Only Memory. The RAM is an abbreviated notation of a Random Access Memory. The storage portion 120 stores a control program 121 executed by the processor 130. Also, the storage portion 120 stores data processed by the processor 130 upon execution of a computer program, and data about the processing result. Further, the storage portion 120 stores map data 123.

The map data 123 includes information related to searching for routes, such as information about nodes corresponding to connection points in road networks such as intersections, and information about links corresponding to roads formed between nodes.

The processor 130 is comprised of a CPU, a microcomputer, a DSP, etc. and controls each part of the control portion 110 by executing a program. The CPU is an abbreviated notation of a Central Processing Unit. The DSP is an abbreviated notation of a Digital Signal Processor. Further, the processor 130 may be a SoC that integrates the processor 130 and the storage portion 120. The SoC is an abbreviated notation of a System-on-a-chip.

The control portion 110 realizes various functional configurations by allowing the processor 130 to execute the control program 121 stored in the storage portion 120. The control portion 110 in the present embodiment includes as the functional configurations, a route searching portion 131 and a sound image localization processing portion 133. Further, the control portion 110 is connected to the wireless communication portion 101, the vehicle information input portion 102, the position detection portion 103, the DSP 105, and the manipulation portion 40.

When the manipulation portion 40 is operated to accept a destination, a search condition, etc., the route searching portion 131 searches for a guidance route from the present position of the vehicle 1 to the destination by the known method such as Dijkstra's Algorithm on the basis of the map data 123 stored in the storage portion 120 and the traffic information or the like acquired from the server device by the wireless communication portion 101. Further, the route searching portion 131 detects as a guide object, a guide crossing that is an intersection included in the searched guidance route.

The sound image localization processing portion 133 allows the speaker array 170 to output predetermined notification sound. The notification sound may adopt, for example, notification sound selected by the rider out of a plurality of notification sounds prepared in advance.

Further, the sound image localization processing portion 133 controls the DSP 105 and the signal amplifying portion 160 to execute sound image localization processing that displaces a position of a sound image of notification sound.

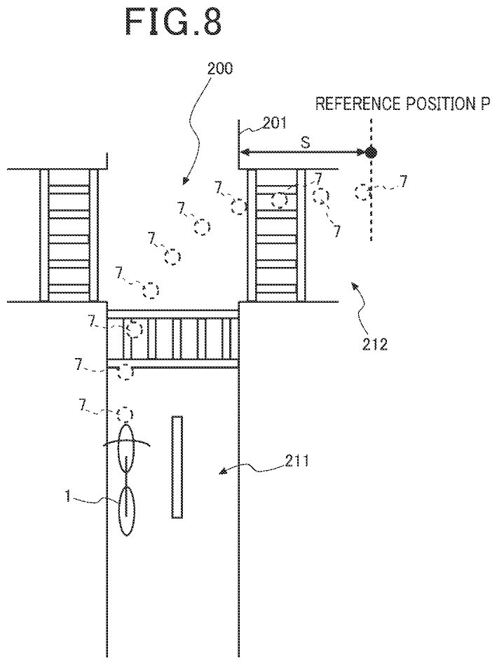

The sound image indicates a virtual sound source, and the localization means determining the position. That is, the localization means making the rider who heard the sound output from the speaker array 170 perceive as if a sound source exists in the position determined by the sound image localization processing portion 133. The sound image localization processing portion 133 controls the volume of the notification sound output by the audio output portion 150 to thereby displace the position to localize the sound image. In the following, the position where the sound image of the notification sound is localized by the sound image localization processing executed by the sound image localization processing portion 133 is referred to as a localization position 7 (refer to FIGS. 8 to 14).

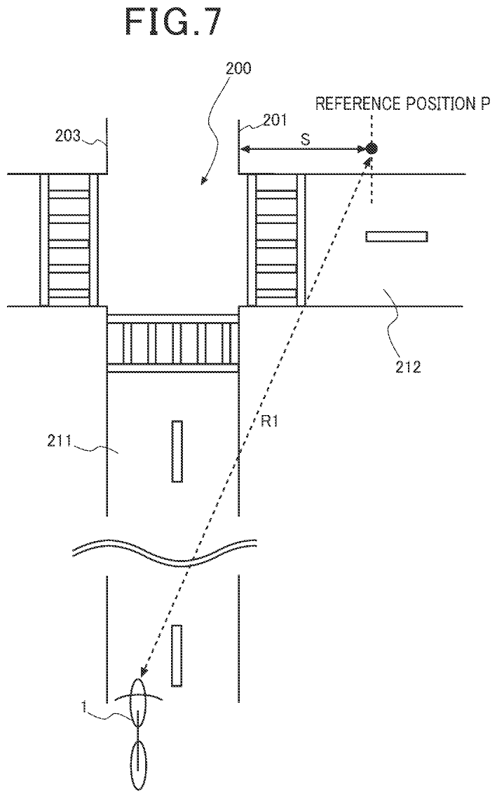

FIG. 7 is a view showing the position of a reference position P.

When the vehicle 1 starts traveling along a guidance route, the sound image localization processing portion 133 determines whether or not the distance from the present position of the vehicle 1 detected by the position detection portion 103 to the reference position P of a guide crossing 200 becomes less than or equal to a first set distance R1. This first set distance R1 may be a linear distance from the present position of the vehicle 1 to the reference position P or may be a traveling distance where the vehicle 1 travels on the guidance route.

The guide crossing 200 shown in FIG. 7 is an intersection where an approach road 211 and an exit road 212 intersect.

The reference position P will now be described with reference to FIG. 7. The reference position P is set to a position of a distance S set in advance from the side end 201, 203 of the guide crossing 200. The side end 201, 203 of the guide crossing 200 is a side end 201, 203 on the traveling lane side of the exit road 212 on which the vehicle 1 that turns right or left on the approach road 211 according to the guidance route travels. The side end of the guide crossing 200 is the side end 201 on the traveling directional side of the vehicle 1. In the example shown in FIG. 7, the side end on the traveling directional side of the vehicle 1 becomes the side end 201 because the guidance route is the right turn. The reference position P is set to the distance S set in advance from the side end 201.

When the reference position P of the guide crossing 200 is set, the sound image localization processing portion 133 determines whether or not the distance to the set reference position P becomes less than or equal to the first set distance R1. When the distance to the set reference position P becomes less than or equal to the first set distance R1, the sound image localization processing portion 133 starts the sound image localization processing. When the sound image localization processing is started, the sound image localization processing portion 133 displaces discretely the localization position 7 of the sound image of the notification sound, corresponding to the guidance route searched by the route searching portion 131. FIG. 8 is a view showing each localization position 7 set in the guide crossing 200. The localization position 7 is shown by a dashed circle in FIG. 8 for convenience of explanation. For example, as shown in FIG. 8, when the guidance route is a route where the vehicle turns right at the guide crossing 200, the localization position 7 of the sound image is set on the route where the vehicle turns right corresponding to the guidance route. Consequently, it is possible to allow the rider to recognize that the guidance route is the right turn route.

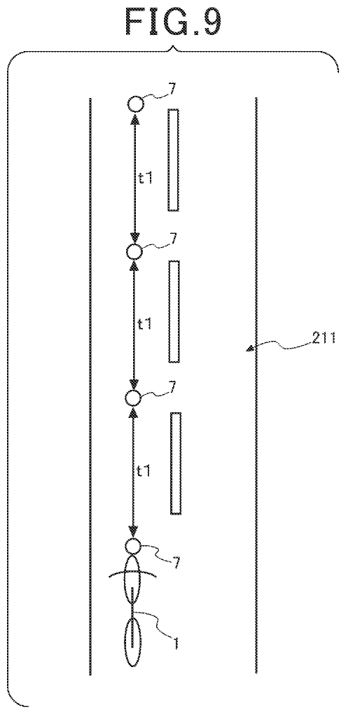

FIGS. 9 to 11 are views each showing an interval between the localization positions 7.

The sound image localization processing portion 133 changes the interval between the localization positions 7, based on the distance to the reference position P.

For example, when the remaining distance to the reference position P is less than or equal to the first set distance R1 and larger than a second set distance R2, as shown in FIG. 9, the sound image localization processing portion 133 controls the audio output portion 150 so that the interval between the adjacent localization positions 7 becomes an interval t1. The interval t1 corresponds to a first interval. Further, the second set distance R2 is a value smaller in value than the first set distance R1.

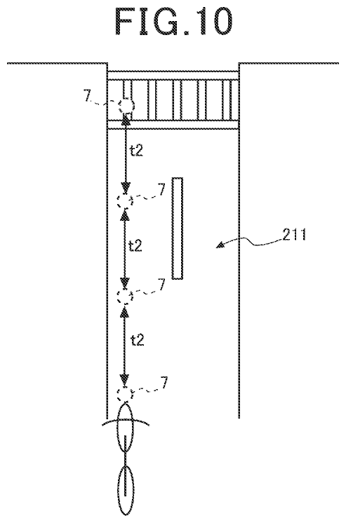

Also, when the remaining distance to the reference position P is less than or equal to the second set distance R2 and larger than a third set distance R3, as shown in FIG. 10, the sound image localization processing portion 133 controls the audio output portion 150 so that the interval between the adjacent localization positions 7 becomes an interval t2. The interval t2 corresponds to a second interval. In addition, the third set distance R3 is a value smaller in value than the second set distance R2.

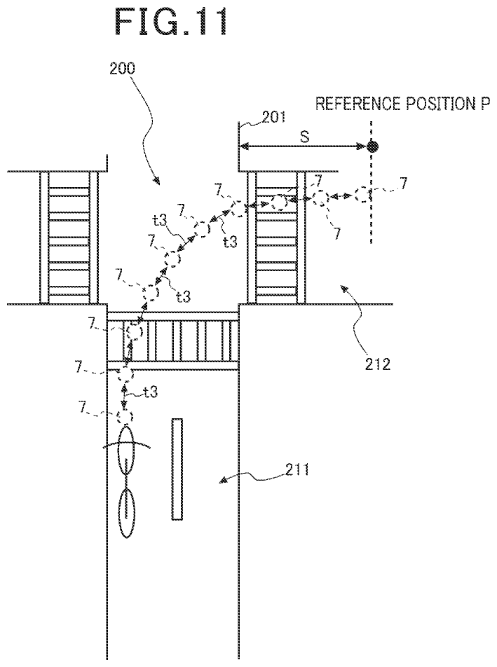

Further, when the remaining distance to the reference position P becomes less than or equal to the third set distance R3, as shown in FIG. 11, the sound image localization processing portion 133 controls the audio output portion 150 so that the interval between the adjacent localization positions 7 becomes an interval t3.

Thus, the shorter the distance to the guide crossing 200, the shorter the interval between the localization positions 7 to localize the sound image of the notification sound. Therefore, the rider is capable of recognizing the remaining distance to the guide crossing 200 by the interval of the notification sound that reaches the rider's ear.

In addition, when the remaining distance to the reference position P becomes less than or equal to a third threshold value, and the distance to the guide crossing 200 gets closer, the sound image localization processing portion 133 displaces the localization position 7 of the sound image of the notification sound in the direction of the exit road 212 from within the intersection of the guide crossing 200. Consequently, the rider of the vehicle 1 is capable of recognizing the direction of traveling on the guidance route.

When the vehicle 1 passes the reference position P, the sound image localization processing portion 133 ends guidance on the guidance route by the sound image of the notification sound. The sound image localization processing portion 133 ends guidance on the guidance route by the sound image of the notification sound until the distance to the next guide crossing 200 becomes less than or equal to the first set distance R1. Thus, when the distance between the adjacent guide crossings 200 is short and less than or equal to the first set distance R1, the guidance on the guidance route by the sound image of the notification sound is performed continuously.

Further, the sound image localization processing portion 133 may guide the direction of traveling of the vehicle 1 by continuously displacing the localization position of the sound image of the notification sound within the guide crossing 200. This processing is especially effective for guidance of a guidance route at an intersection complicated in structure such as a multi-forked road, an annular crossing, or the like.

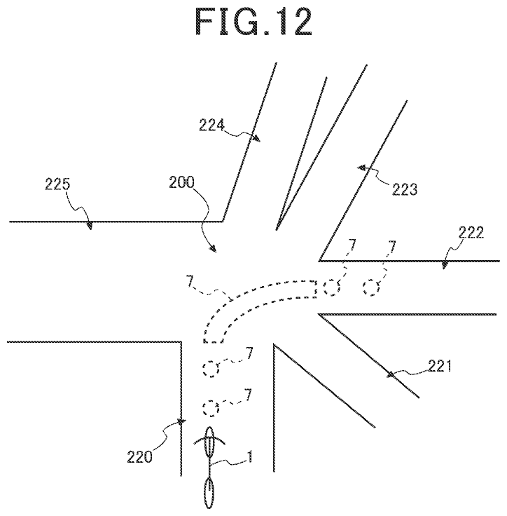

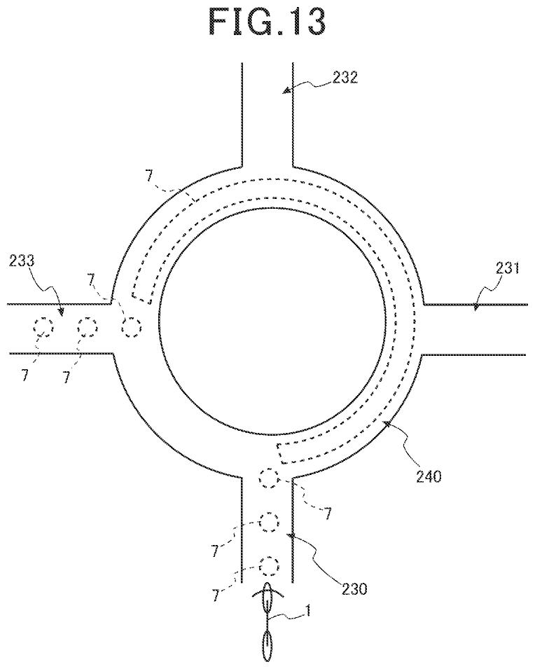

FIG. 12 shows where the guide crossing 200 is the multi-forked road, and FIG. 13 shows where the guide crossing 200 is the annular crossing.

When the localization position 7 is set within the guide crossing 200, the sound image localization processing portion 133 controls the audio output portion 150 so that the localization position 7 is displaced continuously and the notification sound is made continuous without interruption of the notification sound. Further, the sound image localization processing portion 133 displaces the localization position 7 displaced continuously within the guide crossing 200 in the direction of the exit road on the guidance route. For example, the six-forked road shown in FIG. 12 includes a first approach road 220 where the vehicle 1 enters the guide crossing 200, and five exit roads of a first exit road 221, a second exit road 222, a third exit road 223, a fourth exit road 224, and a fifth exit road 225. For example, the second exit road 222 shown in FIG. 12 is assumed to be an exit road following the guidance route. In this case, when the vehicle 1 enters into the guide crossing 200 from the approach road 210, the sound image localization processing portion 133 displaces the localization position 7 in the direction of the second exit road 222 while displacing the localization position 7 continuously. Consequently, the rider is capable of recognizing that the exit road on the guidance route is the second exit road 222.

The annular crossing shown in FIG. 13 is configured so that four roads are connected to one annular road 240. The road where the vehicle 1 enters is an approach road 230, and the exit roads include three of a first exit road 231, a second exit road 232, and a third exit road 233. For example, the third exit road 233 shown in FIG. 13 is assumed to be an exit road following the guidance route.

In this case, when the vehicle 1 enters into the guide crossing 200 from the approach road 210, the sound image localization processing portion 133 displaces the localization position 7 continuously and circularly. Since the notification sound is continuous and uninterrupted when the rider passes through the entrance to the first exit road 231 and the second exit road 232 during traveling on the annular road 240, the rider recognizes the first exit road 231 and the second exit road 232 not to be the exit roads.

Further, when the vehicle 1 travels near the third exit road 233, the sound image localization processing portion 133 temporarily stops the output of the notification sound from the speaker array 170. Thereafter, the sound image localization processing portion 133 discretely displaces the localization position 7 along the third exit road 233 being the exit road following the guidance route. Consequently, the rider is capable of recognizing the direction of traveling along the guidance route to be the third exit road 233.

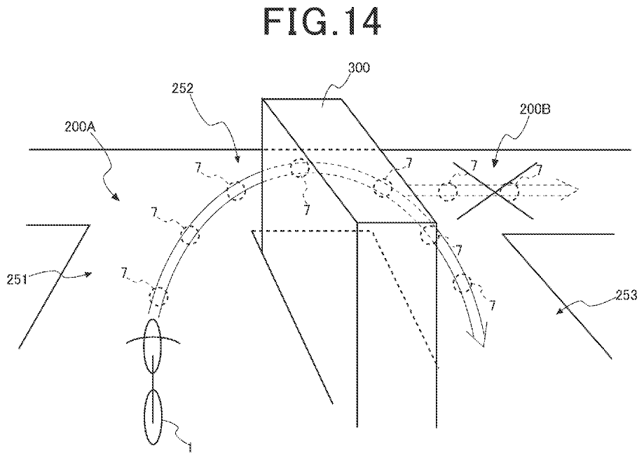

FIG. 14 is a view showing a case where the distance between guide crossings 200 is close, and guidance for a guidance route by a sound image of notification sound is performed continuously.

A first guide crossing 200A and a second guide crossing 200B are shown in FIG. 14. Since the two guide crossings 200A and 200B are close in distance, the sound image localization processing portion 133 continuously performs guidance for the guidance route by the sound image of the notification sound at the two guide crossings 200A and 200B.

Further, a building 300 such as buildings exist between the first guide crossing 200A and the second guide crossing 200B, and a rider traveling on a first road 251 is not capable of recognizing road conditions after turning right on the first road 251. In addition, a guidance route searched by the route searching portion 131 is assumed to be a route on which the rider turns right on the first road 251 to travel on the second road 252 and further turns right on the second road 252 to travel on a third road 253.

The rider who is traveling on the first road 251 does not seem to be able to recognize that the sound image of the notification sound is in the position of the building 300 existing between the first road 251 and the third road 253, and a route after having turned right on the first road 251. However, when the guidance route is a route for the rider to go straight on the second road 252 after turning right on the first road 251, the sound image localization processing portion 133 executes sound image localization processing such that after the localization position 7 of the sound image of the notification sound is displaced in the right direction, the volume of the notification sound decreases and the sound moves away. Further, when the guidance route is a route for the rider to turn right on the second road 252 and enter the third road 253 after turning right on the first road 251, the sound image localization processing portion 133 executes sound image localization processing so that the localization position 7 of the sound image of the notification sound is displaced on the third road 253. Therefore, since the rider is capable of recognizing the notification sound as it comes closer to the rider, the guidance route can be recognized as being a route to turn right on the second road 252 immediately after turning right on the first road 251.

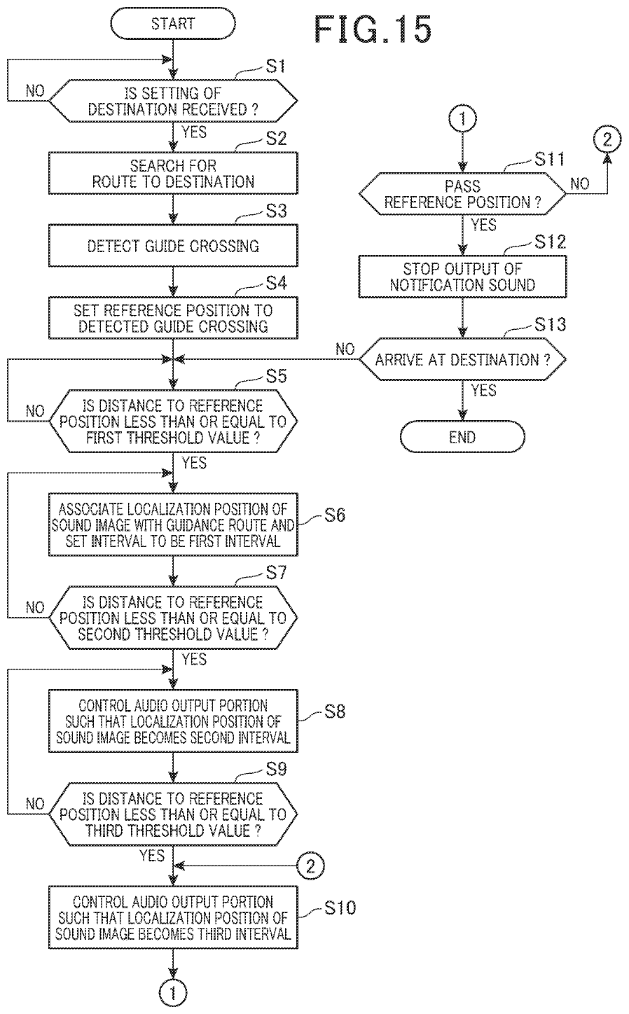

FIG. 15 is a flowchart showing the operation of the control portion 110.

The operation of the control portion 110 will be described with reference to FIG. 15.

At first, the control portion 110 determines whether or not it receives the setting of a destination by the manipulation portion 40 (Step S1). When the destination setting is not received by the manipulation portion 40 (Step S1/NO), the control portion 110 waits for the start of processing until the destination is set.

When the setting of the destination is received (Step S1/YES), the control portion 110 searches for a guidance route to the set destination (Step S2). The control portion 110 searches for the guidance route by, for example, a commonly known search method such as Dijkstra's Algorithm (Step S2).

When the guidance route to the destination is searched for, the control portion 110 detects a guide crossing 200 as a guide object included in the searched guidance route (Step S3). When the guide crossing 200 is detected, the control portion 110 sets a reference position P of the detected guide crossing 200 (Step S4).

Next, the control portion 110 determines whether or not the distance to the reference position P becomes less than or equal to a first set distance (Step S5). When the distance to the reference position P is not below the first set distance (Step S5/NO), the control portion 110 does not perform the output of notification sound (Step S5).

When the distance to the reference position P becomes less than or equal to the first set distance (Step S5/YES), the control portion 110 controls the audio output portion 150 to discretely displace the position to localize a sound image of notification sound output from the speaker array 170 in association with the guidance route. At this time, the control portion 110 controls the audio output portion 150 so that the position to localize the sound image of the notification sound becomes a first interval.

Next, the control portion 110 determines whether or not the distance to the reference position P becomes less than or equal to a second set distance (Step S7). When the distance to the reference position P is not below the second set distance (Step S7/NO), the control portion 110 returns to Step S6 and controls the audio output portion 150 so that the position to localize the sound image of the notification sound becomes the first interval.

Further, when the distance to the reference position P becomes less than or equal to the second set distance (Step S7/YES), the control portion 110 controls the audio output portion 150 so that the position to localize the sound image of the notification sound becomes a second interval (Step S8).

Next, the control portion 110 determines whether or not the distance to the reference position P becomes less than or equal to a third set distance (Step S9). When the distance to the reference position P is not below the third set distance (Step S9/NO), the control portion 110 returns to Step S8 and controls the audio output portion 150 so that the position to localize the sound image of the notification sound becomes the second interval.

Further, when the distance to the reference position P becomes less than or equal to the third set distance (Step S9/YES), the control portion 110 controls the audio output portion 150 so that the position to localize the sound image of the notification sound becomes a third interval (Step S10).

Next, the control portion 110 determines based on a detection result of the position detection portion 103 whether or not the vehicle 1 passes the reference position P (Step S11). When the vehicle 1 does not pass the reference position P (Step S11/NO), the control portion 110 continues to output the notification sound from the speaker array 170 and controls the audio output portion 150 so that the position to localize the sound image of the notification sound becomes the third interval (Step S10).

Further, when the vehicle 1 passes the reference position P (Step S11/YES), the control portion 110 stops the output of the notification sound from the speaker array 170 (Step S12). Thereafter, the control portion 110 determines whether or not the vehicle 1 arrives at the destination (Step S13). When the vehicle 1 does not arrive at the destination (Step S13/NO), the control portion 110 returns to Step S5. Further, when the vehicle 1 arrives at the destination (Step S13/YES), the control portion 110 ends this processing flow.

As described above, the control device 100 of the present embodiment has the plurality of speakers 171 to 178 and includes the audio output portions 151, 153, and 155 mounted on the vehicle 1, the route searching portion 131 that searches for the guidance route to the destination, and the sound image localization processing portion 133 that controls the audio output portions 151, 153, and 155 based on the guidance route searched by the route searching portion 131 and that discretely displaces the position to localize the sound image of the predetermined notification sound output from each of the speakers 171 to 178 in association with the guidance route.

Thus, since the position to localize the sound image of the predetermined notification sound output from each of the speakers 171 to 178 is discretely displaced corresponding to the guidance route, route information can be notified to the rider in an easy-to-understand manner.

Also, the control device 100 includes the position detection portion 103 that detects the position of the vehicle 1. The sound image localization processing portion 133 may be configured to cause the distance to the guide object where guidance in the direction of traveling of the vehicle is planned in the guidance route to be notified of, by changing the interval between the positions to localize the sound image.

Thus, since the distance to the guide object can be notified to the rider by changing the interval of the notification sound, the route information can be notified to the rider in an easy-to-understand manner.

Further, the sound image localization processing portion 133 may be configured to displace the position to localize the sound image for each first interval when the distance to the guide object is less than or equal to the first set distance and to displace the position to localize the sound image for each second interval shorter than the first interval when the distance to the guide object is less than or equal to the second set distance smaller in value than the first set distance.

Thus, since the distance to the guide object can be notified to the rider by changing the interval of the notification sound, the route information can be notified to the rider in an easy-to-understand manner.

Furthermore, the route searching portion 131 detects the guide crossing 200 as the guide object. The sound image localization processing portion 133 may be configured to, when the vehicle 1 is traveling on the approach road where the vehicle 1 enters the detected guide crossing 200, and the distance to the guide crossing 200 becomes less than or equal to the third set distance smaller in value than the second set distance, displace the position to localize the sound image of the notification sound from within the guide crossing 200 in the direction of the exit road where the vehicle exits the guide crossing 200.

Thus, the direction of the exit road in the guide crossing 200 can be notified to the rider in an easy-to-understand manner.

In addition, the sound image localization processing portion 133 may be configured to, when the guide object is the guide crossing 200, set the reference position to the position of the distance set in advance from the side end of the guide crossing 200 and to change the position to localize the sound image by the first interval or the second interval on the basis of the distance from the present position of the vehicle 1 to the reference position.

Thus, it is possible to set the reference position to the determined position of the guide crossing 200 and change the interval to localize the sound image, based on the distance to the set reference position. Therefore, it makes it easier for the rider to recognize the distance to the guide crossing 200.

Further, the sound image localization processing portion 133 may be configured to continuously displace the position to localize the sound image within the guide crossing 200.

Thus, the guidance on the traveling direction in the guide crossing can be notified to the rider in an easy-to-understand manner.

Furthermore, the sound image localization processing portion 133 may be configured to prevent the speakers 171 to 178 from outputting the notification sound when the distance to the guide object is away from the first set distance.

Thus, it is possible to reduce power consumption of the vehicle 1.

The above-described embodiment is a preferred embodiment of the present invention. The gist of the present invention is, however, not limited to the above-described embodiment, and various modifications can be implemented.

For example, although the above-described embodiment has been described by taking as an example the case where the guide object is the guide crossing 200, the guide object is not limited only to the crossing, but may be, for example, a branch, a confluence and an exit on a highway.

Further, although the above-described embodiment has described the case where the interval of the sound image of the notification sound is changed in three stages of the interval t1, the interval t2, and the interval t3, the number of stages that change the interval may be more or may be less than the number of three stages.

### REFERENCE SIGNS LIST

1 Vehicle

7 Localization position

10 Body frame

11 Power portion

12 Front fork

13 Front wheel

14 Steering handlebar

15 Swing arm

16 Rear wheel

17 Seat

18 Body cover

20 Front screen

21 Meter panel

23a Call start button

25 Instruments

26 Instruments

40 Manipulation portion

41 Handlebar manipulation portion

42 Handlebar manipulation portion

43 Central manipulation portion

51 Rider seat

53 Pillion passenger seat

55 Left mirror

57 Right mirror

71 Vehicle speed sensor

100 Control device

101 Wireless communication portion

102 Vehicle information input portion

103 Position detection portion

105 DSP

110 Control portion

120 Storage portion

121 Control program

130 Processor

131 Route searching portion

133 Sound image localization processing portion

140 Audio input portion

145 Controller board

150 Audio output portion

160 Signal amplifying portion

170 Speaker array

171 First speaker

172 Second speaker

173 Third speaker

174 Fourth speaker

175 Fifth speaker

176 Sixth speaker

177 Seventh speaker

178 Eighth speaker

161 First AMP

162 Second AMP

163 Third AMP

164 Fourth AMP

165 Fifth AMP

166 Sixth AMP

167 Seventh AMP

168 Eighth AMP

211, 220, 230 Approach road

212 Exit road

221, 231 First exit road

222, 232 Second exit road

223, 233 Third exit road

224 Fourth exit road

225 Fifth exit road

240 Annular road.

1. A route guiding apparatus comprising:
an audio output portion including a plurality of speakers and mounted on a vehicle;
a route searching portion searching for a guidance route to a destination; and
a sound image localization processing portion controlling the audio output portion based on the guidance route searched by the route searching portion, the sound image localization processing portion discretely displacing a position in association with the guidance route, the position being for localizing a sound image of predetermined notification sound output from each of the speakers.

2. The route guiding apparatus according to claim 1, further including a position detection portion that detects a position of the vehicle,
wherein, in the guidance route, the sound image localization processing portion causes a distance to be notified of by changing an interval between positions to localize the sound image, the distance being a distance to a guide object where guidance in a traveling direction is planned.

3. The route guiding apparatus according to claim 2,
wherein, when the distance to the guide object is less than or equal to a first set distance, the sound image localization processing portion displaces the position to localize the sound image for each first interval, and
when the distance to the guide object is less than or equal to a second set distance, the sound image localization processing portion displaces the position to localize the sound image for each second interval, the second set distance being smaller in value than the first set distance, and the second interval being shorter than the first interval.

4. The route guiding apparatus according to claim 3,
wherein the route searching portion detects a guide crossing as the guide object, and
when the vehicle is traveling on an approach road where the vehicle enters the detected guide crossing, and a distance to the guide crossing becomes less than or equal to a third set distance, the sound image localization processing portion displaces the position to localize the sound image of the notification sound from within the guide crossing in the direction of an exit road where the vehicle exits the guide crossing, the third set distance being smaller in value than the second set distance.

5. The route guiding apparatus according to claim 4, wherein when the guide object is the guide crossing, the sound image localization processing portion sets a reference position to a position of a distance set in advance from a side end of the guide crossing, and the sound image localization processing portion changes the position to localize the sound image by the first interval or the second interval on the basis of a distance from the present position of the vehicle to the reference position.

6. The route guiding apparatus according to claim 4 or 5, wherein, within the guide crossing, the sound image localization processing portion continuously displaces the position to localize the sound image.

7. The route guiding apparatus according to claim 3, wherein the sound image localization processing portion prevents the speakers from outputting the notification sound when the distance to the guide object is away from the first set distance.
